(19) United States
(12) Patent Application Publication
(10) Pub. No.: US 2016/0189309 A1
(43) Pub. Date: Jun. 30, 2016

(54) System for Accessing and Processing Information

(71) Applicant: Associated Reporting Group, Inc., Cottonwood Heights, UT (US)

(72) Inventors: Thomas O. Bushell, Cottonwood Heights, UT (US); Arnold J. Swenson, Cottonwood Heights, UT (US)

(21) Appl. No.: 14/878,991

(22) Filed: Oct. 8, 2015

Related U.S. Application Data
(60) Provisional application No. 62/061,531, filed on Oct. 8, 2014.

(51) Int. Cl. G06Q 40/08; G06Q 50/16

(52) U.S. Cl. CPC G06Q 40/08; G06Q 50/163

(57) ABSTRACT

A method for procuring and tracking evidence of insurance, the method under control of one or more computer systems configured with executable instructions, includes a processor which operates to receive an evidence of insurance request from a user corresponding to a specific collateralized property, said request comprising information corresponding to the specific collateralized property; generate and assign a permanent unique code for the collateralized property corresponding to insurance information for the collateralized property; create a profile of insurance information on a first database corresponding to the collateralized property; access insurance information related to the collateralized property on a second database to obtain insurance information corresponding to the collateralized property; confirm the existence of insurance for the collateralized property; and generate an electronic evidence of insurance document.

### PRIORITY

This application claims priority to U.S. Provisional Patent Application No. 62/061,531 filed on Oct. 8, 2014 entitled “Improved System for Accessing and Processing Information” which is incorporated herein in its entirety by reference.

### FIELD OF THE TECHNOLOGY

This technology relates generally to the methods and systems for accessing and processing information. Specifically, it relates to systems and processes for updating, retrieving, and processing evidence-based documentation of insurance.

### BACKGROUND

Ever since insurance has been available there has been a need to verify the accuracy of the claim of having insurance. This is because the law requires automobiles to be insured and lenders require mortgaged property to be insured. The current method of verification involves simply reading the insurance card or policy as it was originally written by the insurance company and physically calling the insurance company for verification. Collateralized loans (e.g., mortgages) in America require a tangible, up-to-date Evidence of Insurance (“EOI”) document from the insurance carrier on the collateral property in order to close the loan. The EOI is used to verify that the lending institution is secured from loss on its mortgage loan in the event the associated property is damaged or destroyed during the life of the mortgage. In 2013, there were 8.7 million primary property mortgages or refinances. This means that a minimum of 8.7 million EOIs were obtained that year. This figure excludes the number of mortgages then sold to a processor and excludes second mortgages, each of which also requires an EOI. This figure also excludes collateralization of vehicles which also requires an EOI. Historically and presently, an EOI is obtained by a mortgage broker/lender from the borrower's homeowner/property insurance company. The process to obtain an EOI document is a labor intensive process. Additionally, because it is a manual and administrative-only process, the existing EOI process is subject to two inherent problems, first, delays in processing and timely turnaround and secondly, mistakes that result in further delays.

### SUMMARY

In light of the problems and deficiencies inherent in the prior art, the present technology seeks to overcome these by providing methods, devices, and systems for improved access to and processing of information. In accordance with one aspect of the technology, a method for procuring and tracking evidence of insurance, the method under control of one or more computer systems configured with executable instructions is disclosed. The method uses a specially programmed processor which operates to receive an evidence of insurance request from a user corresponding to a specific collateralized property, said request comprising information corresponding to the specific collateralized property. The processor generates and assigns a unique code for the collateralized property corresponding to insurance information for the collateralized property and creates a profile of insurance information on a first database corresponding to the collateralized property. The processor also accesses insurance information related to the collateralized property on a second database to obtain insurance information corresponding to the collateralized property. The processor updates the profile of insurance information on the first database and confirms the existence of insurance for the collateralized property. In addition, the processor generates an electronic evidence of insurance document and transfers an evidence of insurance document to the user.

### BRIEF DESCRIPTION OF THE FIGURES

To further clarify the above and other aspects of the present technology, a more particular description of the technology will be rendered by reference to specific aspects thereof which are illustrated in the appended drawings. It is appreciated that these drawings depict only typical aspects of the technology and are therefore not to be considered limiting of its scope. The drawings are not drawn to scale. The technology will be described and explained with additional specificity and detail through the use of the accompanying drawings in which:

FIG. 1 is a flow chart illustrating work flow in accordance with aspects of the current technology;

FIG. 2 is a flow chart illustrating work flow in accordance with aspects of the current technology;

FIG. 3 is a flow chart illustrating work flow in accordance with aspects of the current technology;

FIG. 4 is a flow chart illustrating work flow in accordance with aspects of the current technology;

FIG. 5 is a flow chart illustrating work flow in accordance with aspects of the current technology; and

FIG. 6 is a flow chart illustrating work flow in accordance with aspects of the current technology.

### DETAILED DESCRIPTION OF THE ILLUSTRATED TECHNOLOGY

The following detailed description of exemplary aspects of the technology makes reference to the accompanying drawings, which form a part hereof and in which are shown, by way of illustration, exemplary aspects in which the technology may be practiced. While these exemplary aspects are described in sufficient detail to enable those skilled in the art to practice the technology, it should be understood that other aspects may be realized and that various changes to the technology may be made without departing from the spirit and scope of the present technology. Thus, the following more detailed description of the aspects of the present technology is not intended to limit the scope of the technology, as claimed, but is presented for purposes of illustration only and not limitation to describe the features and characteristics of the present technology, to set forth the best mode of operation of the technology, and to sufficiently enable one skilled in the art to practice the technology. Accordingly, the scope of the present technology is to be defined solely by the appended claims. The following detailed description and exemplary aspects of the technology will be best understood by reference to the accompanying drawings, wherein the elements and features of the technology are designated by numerals throughout.

The advent of cloud-based computing architectures has opened new possibilities for the rapid and scalable deployment of virtual Web stores, media outlets, and other online sites or services. In general, a cloud-based architecture deploys a set of hosted resources such as processors, operating systems, software and other components that can be combined or strung together to form virtual machines. A user or customer can request the instantiation of a virtual machine or set of machines from those resources from a central server or management system to perform intended tasks or applications. For example, a user may wish to set up and create a virtual server from the cloud to create a storefront to market products or services on a temporary basis, for instance, to sell tickets to an upcoming sports or musical performance. The user can lease or subscribe to the set of resources needed to build and run the set of initiated virtual machines on a comparatively short-term basis, such as hours or days, for their intended application. Aspects of the technology described herein can be employed on cloud-based computing architectures or other network systems.

In the following description, certain terminology is used to describe certain features of one or more aspects of the technology. For instance, “network” includes any communication link between two or more devices. The term “database” is used to represent the collection of data in one or more data structures, lists, components, etc. The term “remote” (e.g., remote computer) refers to a location which is physically distant from a referred location. The term “server” refers to a computer or computer program that manages access to a centralized resource or service in a network.

The present technology in its various aspects, some of which are depicted in the figures herein, can be broadly described as a method and system for updating, retrieving, and processing evidence-based documentation of insurance. Typically, an EOI is obtained via a phone, fax, or email request from the borrower's broker/lender to the borrower's property insurance company. The borrower's insurance company's agent or administrative staff manually completes the evidence of insurance form and submits it back to the lender/broker. Delays in loan closings can be costly in terms of real dollars from the loss of locked-in rates, the insurance company personnel labor and administrative costs, and general frustration and time-loss among borrowers, lenders, processors, and insurance companies. The problems can be costly to the borrower, the broker, and the insurance company. Thus, there is a need to improve turnaround time and consistency and save administrative costs of insurance companies. Moreover, there is a need for a secured system for requesting changes to insurance company policy information related to subject properties. At present, anonymous individuals could request changes to the policy under the guise of the need for an accurate EOI document in order to create confusion and problems with a subject property.

System Initialization and Database Creation

Broadly speaking, aspects of the technology reside in a method and system to update, retrieve, and process EOI documentation. The end result being, in one aspect, an EOI document transferred to a lender or other interested party having enhanced properties. In one aspect of the technology, a server at a remote location contains computer readable code executable to provide a webpage accessible by a remote device, tablet, cell-phone, desktop, laptop, or otherwise. The webpage provides a graphic-user-interface wherein users may set up an account and create an account profile. The account requires the user to supply a user address, username, email address, login name, tax identification number, secured payment information (e.g., credit card authorization, etc.), and in the case of mortgage lenders, the user's Nationwide Mortgage Licensing System (“NMLS”) number. Additional or less information may be required as suits a particular scenario. For example, a user name, business license or number may also be used. Once entered, an email is sent to the email address requiring verification of the email and account set up. A unique EOI account number is then assigned to the user wishing to access the EOI System.

Once the initial account is set up, a user is provided general access to the EOI system. The EOI system communicates with a database containing insurance information related to specific collateralized properties. In one aspect of the technology, the database contains information that is collected from a user regarding a collateralized property. The information includes the (i) borrower's name and address, (ii) if the property is real estate (property consisting of land and/or building), the property address, or if the property is a vehicle the vehicle identification number (“VIN”), (iii) insurance company, (iv) address of insurance company, and (v) insurance policy number, (vi) property type, (vii) loan amount, (viii) lender, (ix) escrow, (x) loan number, and (xi) lien position. In one aspect of the technology, the purpose of the request is also input by the user. For example, if the EOI is requested as the result of a loan, the loan purpose is input (e.g., purchase, cash-out refinance, etc.). If the EOI is requested as the result of a change in insurance company, that information is also input and so on. In one aspect of the technology a mortgagee clause is also input by the user.

In one aspect of the technology, and specifically with respect to mortgages for real estate, the user may upload a file to the EOI server having the information referenced above. For example, a Fannie Mae 3.2 file is prepared in connection with loan processing associated with real estate mortgages. Much of the information required to initiate an EOI request is present in that file. A user of the EOI system can upload this electronic file to the EOI server. The EOI server locates and extracts the information required to initiate the EOI request and deletes the Fannie Mae 3.2 file. In another aspect, the user may launch an application found on the EOI website that reads a file located on the user's computer. Similar to the uploaded file, the file located on the user's computer is read by the application and information required to initiate an EOI request is extracted and made available for the EOI System.

Once the information required to initiate an EOI request is stored on the database a quality control step is completed. In one aspect of the technology, the address entered for the real estate by the user (or extracted from the electronic file) is compared with the United States postal system database. In the event a vehicle is the collateralized property, the VIN number is cross-referenced with department of motor vehicles. If information regarding either of the two entries is inconsistent with the public records regarding the collateralized property, the user is prompted to reconcile the inconsistency by accepting the entered information, accepting the public records information, or entering additional information.

In one aspect of the technology, the collateralized property is assigned an EOI identifier. The EOI identifier is a unique code that corresponds to information stored on the EOI database for each piece of collateralized property. In one aspect, the code is assigned to the collateralized property for the “life” of the property and is used exclusively by the EOI system. In other words, the code is a unique number that corresponds to a piece of collateralized property and acts as a pointer to a database entry corresponding to EOI information specific to the collateralized property and is permanently affixed to the specific property every time for which a request for an EOI document is generated. In another aspect, the EOI code corresponds solely to the request for an EOI document. That is, when a user enters the EOI code into the EOI system, a transaction record is created to identify that specific request and the details related to the request. The EOI code is formatted similarly for all types of collateralized property be it real estate or vehicles. In this manner, access to the EOI system and EOI information is streamlined as any request uses a reference number having a similar format regardless of the type of collateralized property for which information is sought. The EOI code stays with the collateralized property even when the property is no longer collateralized (i.e., the loan is paid off) so that the same code may be used for future transactions where the property becomes collateralized in the future. In this manner, the history of collateralization of the property may be accounted for and analyzed to understand the sufficiency of coverage related to the property. In one aspect of the technology, the EOI code is placed on every EOI document for future use. The code may be placed anywhere on the page, but in a preferred aspect, the code is placed in the bottom right hand corner to facilitate quicker processing. The EOI code may be presented as a specific URL, barcode, QR Code, or other suitable machine readable process.

Information that is required to initiate the EOI process is then reconciled with an EOI database. This step is referred to herein as the EOI reconciliation step. If insurance is accurate (e.g., the loss payee is correct, insurance amounts are correct, etc.) and up-to-date, an EOI electronic document is prepared and sent to the borrower, insurance agent, mortgage broker, and/or lender that verifies the collateralized property is properly insured against loss. That is, the EOI is made available to the requester, whomever that may be, through an EOI system account. In one aspect of the technology, a database housing the required EOI information is established and used for EOI reconciliation. The database is created by information input by a user through the EOI website and graphical-user-interface or extracted from uploaded (or searched) electronic files. Database entries are time and date stamped to record transaction times, but otherwise only information required for EOI processing is collected and maintained. In another aspect, the EOI database is created by the receipt of information from insurance companies. In this aspect, the EOI database is populated with EOI information that insurance companies send to the EOI server. Only that information required to reconcile EOI is received from the insurance company. When changes are made to insurance policies at the insurance company, those changes are sent to the EOI database which is updated so correct EOI information may be presented to borrowers and other interested parties. In another aspect of the technology, the EOI reconciliation step does not access and EOI database, rather it accesses individual insurance company databases to reconcile EOI information. In this aspect, rather than having a repository of separately stored information related to collateralized property, the EOI server accesses information stored directly on an insurance company database to reconcile the EOI request in order to provide the EOI document.

In accordance with another aspect of the technology, a qualified user may access the EOI website in order to initiate an EOI request. However, the qualified user may wish to effectuate a change to previous insurance information. For example, where an existing home is being purchased by a new person who has insurance different from the previous owner and a lender (i.e., the loss payee), insurance records on the collateralized property will require revision. In this aspect, a qualified user accesses the EOI website and enters existing information regarding the collateralized property. If the property has been previously assigned an EOI code, the user need only scan or enter the EOI code for the property. The user may then view existing information with respect to the collateralized property and is prompted to accept or make changes to certain fields of EOI information (i.e., changes to name of loss payee, insurance policy, etc.). The qualified user can make changes to the EOI information which are then recorded in a temporary database entry associated with the collateralized property. The EOI database (via the EOI server or otherwise) communicates with an insurance provider to validate that the requested changes are correct. Once validated by the insurance company, the EOI database is modified per the qualified user's request. In another aspect of the technology, the qualified user may access the EOI website intending to make changes to the EOI database entry. However, in the case where the EOI database is automatically updated via direct communication with insurance company databases, no change is required. Aspects of the current technology solve the technical hurdle of requiring a central database or program that consolidates all of the data from the different insurance companies. Each company is unique in how they handle existing data. They each have and use unique software to manage their companies. The end result is an inability to effectively procure data that is not fragmented. This often results in a manual or partially manual process to provide the information as needed. Aspects of the present technology connects to each insurance company through the use of custom API's. This allows the users to obtain the information needed, make corrections and correspond with the policy holder, the agent and insurance company at the same time from one location. The system also has the ability to process multiple requests for different agencies at the same time. This fixes the current hurdle of having to manually obtain the information from each company and adjust inconsistencies between formatting of property data.

### Example No. 1

### Collateralization or Refinance of Collateralized Property

When a property is acquired by an entity requiring borrowed funds, the lending institution will hold the property, in one form or another, as collateral against the loan. This is referred to as collateralization of the property. That is, if the borrower defaults on the loan, the lender is entitled to take possession of the property. As a condition of the loan, the borrower is required to maintain insurance on the property against certain losses to protect the borrower's interest in the property. In one aspect of the technology, with reference to real estate, a mortgage broker, loan originator, or insurance agent, for example, accesses the EOI website and initiates an EOI request. Information with respect to the property is entered in order to initiate the request. When the collateralized property has been assigned an EOI code, that code may be input by the user to initiate the EOI request. In one aspect of the technology, a borrower has already secured insurance on the collateralized property. In that instance, the user simply initiates an EOI request and an EOI document is generated. Where information regarding insurance needs to be changed before an EOI request is made, the user request changes and awaits reconciliation of the EOI database or insurance company database before an EOI document is generated. In the event the requested change to the EOI information is not reconcilable with insurance information or the EOI database, the user is provided with an appropriate notice and prompted to check the entered information and/or contact an EOI servicer to assist them with the EOI request.

A similar process is employed to refinance collateralized property. That is, evidence of insurance by the lender is still required. In this instance, it is likely that the insurance provider and lender information has not changed and a mortgage broker can simply access the EOI web site and initiate an EOI request. To the extent insurance information and/or lender information has changed, a process similar to that for a new purchase will be followed.

In one aspect of the technology, whenever the user of the EOI system indicates the EOI request is initiated in response to a purchase or refinance, a notification is generated and sent to participating insurance agents or insurance companies indicating that a refinance or sale is taking place. Additional information may also be available to be provided to whomever the insurance company desires. For example, appraisal value, number of occupants, etc. In instances where the EOI request is initiated by a lender, the insurance agent may wish to know that a sale or refinance is taking place as an opportunity to visit with the owner of the collateralized property to revisit insurance needs.

### Example No. 2

### Batch Transfer of Debt Portfolio

Once a mortgage is created with respect to a piece of collateralized property it can be bought and sold like any other piece of property. In many instances, mortgages having similar interest rates and terms are packaged and sold in batches to businesses that buy and sell mortgages and/or mortgage backed securities. In some instances, mortgages can be packaged in as many as 500 units. In this instance, an EOI must be generated for each piece of collateralized property in the transfer. In accordance with one aspect of the technology, a user accesses the EOI website and initiates a batch EOI request. Because batch transfers of mortgages primarily happen within months of the creation of the mortgage, changes in insurance are unlikely. The change in ownership of the mortgage, and hence a change in the loss payee on the policy are all that would be required to generate an acceptable EOI document. In a preferred aspect, the user need only enter the EOI code for each piece of collateralized property and the new loss payee. The EOI code identifies each property and initiates a request to change the loss payee in the EOI database and/or in the insurance company database. Once the change to the loss payee has been effectuated, an EOI document is generated for each member of the batch and sent to the user.

In one aspect of the invention, the purchaser of the debt portfolio is provided with EOI documentation having the EOI code placed on each EOI document for each piece of collateralized property. An applet is downloaded on a mobile phone, tablet, or other device capable of interfacing with the camera or scanner associated with the device to convert the EOI code on the EOI document to a code transferable to the EOI website. For example, in one aspect of the invention, the EOI code for each member of a batch transfer is uploaded to the EOI website by scanning the EOI code on each EOI document. The user need only make a single manual entry indicating that all members of the batch change or add the new owner of the batch as a loss payee to the insurance of the batch.

### Example No. 3

### Change in Insurance Provider

In some instances, insurance provided to a piece of collateralized property, such as a home, is changed due to a homeowner's wish to change providers. In this instance, the loss payee will not change, but the insurance provider and attendant policy information associated with the policy will change. In accordance with one aspect of the invention, a user accesses the EOI website and indicates that a change in insurance provider is requested. In this aspect, the user will not be able to change loss payee information or any information with respect to the loan, etc., but will be prompted to verify collateral information by entering the EOI code, for example, or other information. The user then enters the new policy information and requests EOI reconciliation. The EOI server accesses the EOI database and/or the insurance company database to reconcile the request. Once the request is validated, an EOI document is generated.

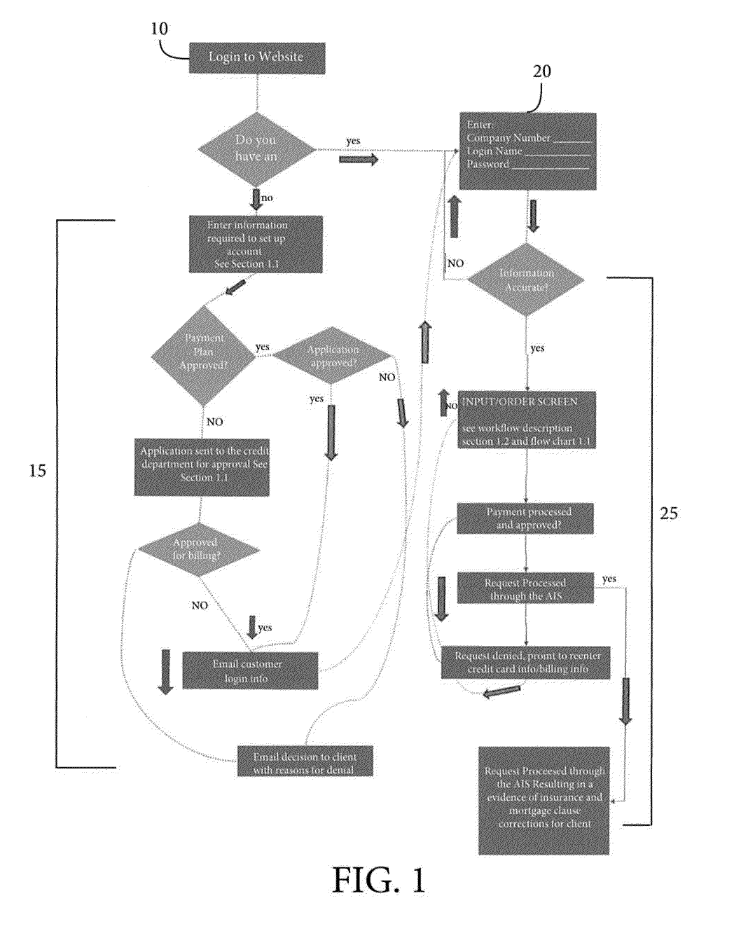

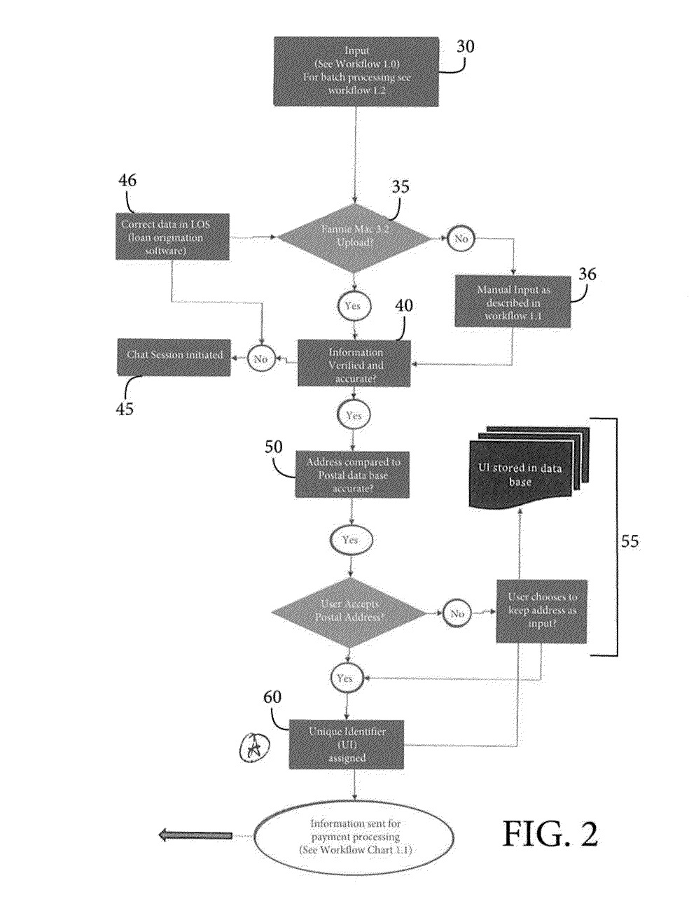

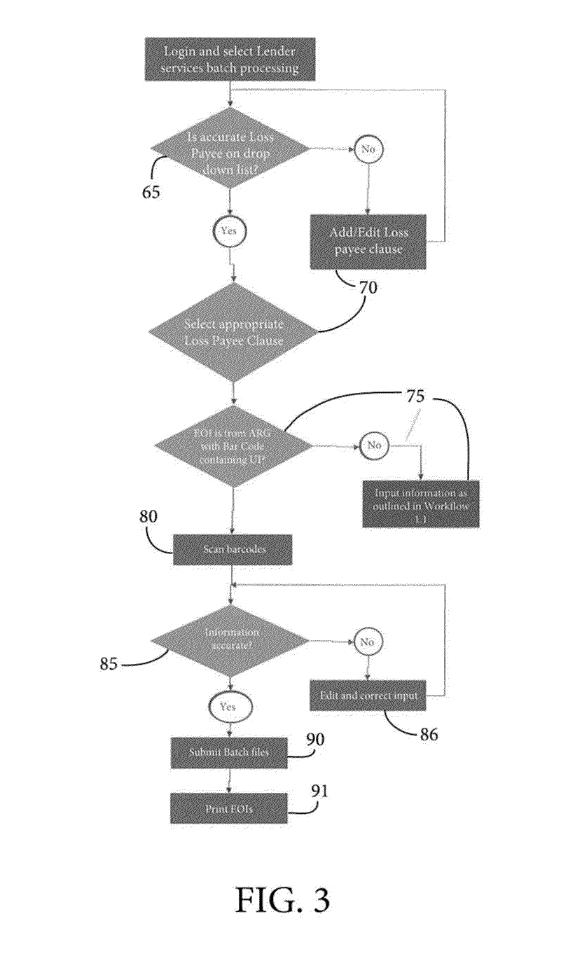

With reference now to FIG. 1, generally speaking, a user can login to a website at step 10, if a pre-existing account has not been set up, the user is prompted to create an account at steps 15. If an account exists, the user is prompted to enter account information at step 20. Once the user has logged into the system, the user is directed to the input screen and a request is made and processed at steps generally indicated at 25. With reference to FIG. 2, at the user input step 30 the user may upload a Fannie Mae form 35 with real estate loan information provided therein. If the form 35 is uploaded it is validated at step 40. If the information is incorrect a chat session with an assistant may be initiated 45 and/or the user is prompted to correct the loan information 46. Alternatively, instead of uploading a Fannie Mae form 35, the user may manually enter loan information at step 36. Manual entry is also subject to validation at step 40 and/or correction at step 46. The address entered in steps 35 or 36 is compared to the address in a database 50 and the address is accepted and stored as the correct real estate address at steps shown at 55. After the address is accepted and stored at steps 55, a unique identifier (numerical, alphanumeric, or otherwise) 60 is assigned to the real estate address. The unique identifier 60 is assigned by the EOI system for future reference in generating future EOI documents and is intended to remain as an identifier for the real estate so long as the real estate remains intact. With reference to FIG. 3, in accordance with one aspect of the technology, a method of requesting and/or generating a batch of EOI documents is presented. Generally speaking, batch submissions will be completed as part of an acquisition of a large number of mortgages. In this instance, the loss payee clause for a large number of mortgages requires modification. In accordance with one aspect of the technology, the user is prompted to identify the new loss payee from a drop down list 65 and/or add it to the loss payee clause of the mortgage at steps shown at 70. To the extent the mortgage had not previously been assigned an EOI unique identifier as described above, the user is prompted to take those steps necessary to procure one at step 75. In the event, the mortgaged property has a unique identifier, the unique identifier can be hand entered and/or, in the event a bar code has been assigned to the mortgage, the bar code can be scanned 80. Once the barcodes are scanned, the system uploads the mortgage information which is provided to the user for verification of accuracy 85. If information requires correction, the user is prompted to update the data 86. Once the data is verified, the batch is submitted 90 and EOI documents are generated 91. In accordance with one aspect of the technology, the unique identifier may comprise multiple components corresponding to different data points. For example, a first part of the unique identifier corresponds to the postal address of the property or VIN number of the vehicle and remains with the property as long as it is in existence. A second part of the number comprises a dynamic component corresponding to the number of times an EOI document has been requested for the property, the date of the latest request or first request, etc.

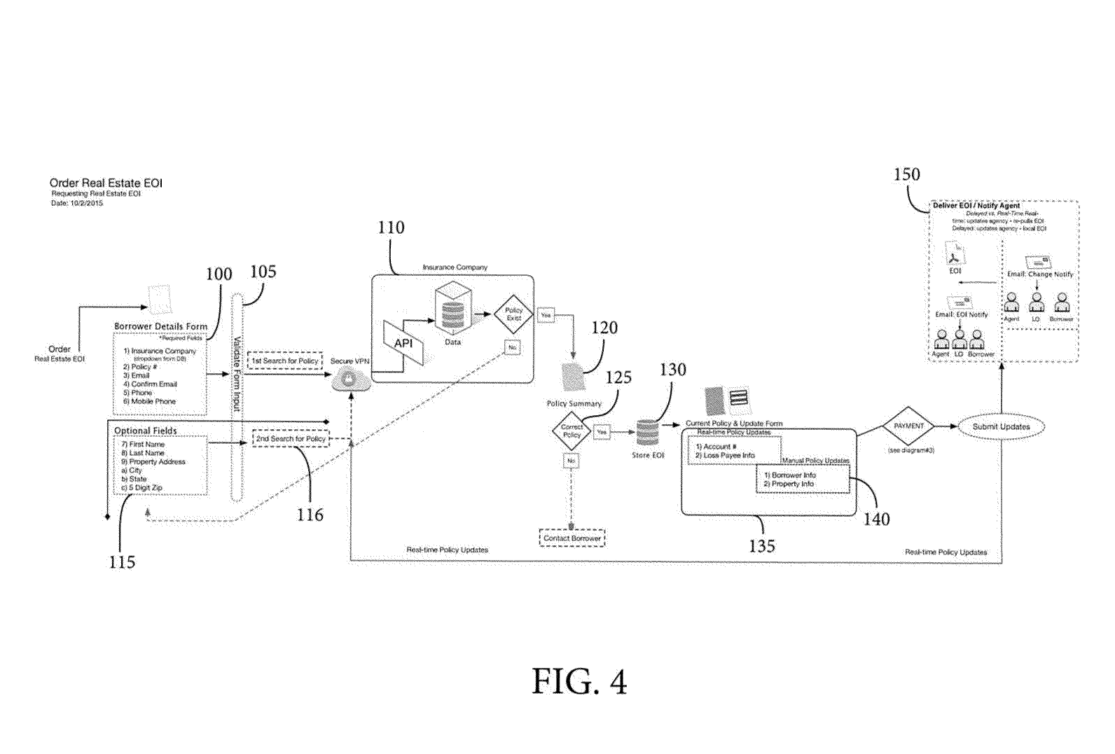

With reference to FIG. 4, in accordance with one aspect of the technology, a system and/or process for ordering an EOI document is disclosed. At step 100, the user enters the details of the borrower on the mortgaged property. For example, the user may enter the name of the insurance company, the policy number, the e-mail, and phone number of the borrower. The borrower information is validated at step 105. The system searches for the policy by interfacing via an API at step 110 with data stored by the insurance company identified in step 100. In computer programming, an application programming interface (API) is a set of routines, protocols, and tools for building software applications. An API expresses a software component in terms of its operations, inputs, outputs, and underlying types. In this instance, the API interfaces with the insurance company data to determine if the policy input by the user at step 100 exists. If it does not exist, then additional information is requested at step 115. A second search 116 of the insurance company database is provided in order to locate the relevant insurance policy information. Once the insurance policy data has been located and the policy is confirmed to exist, a policy summary is generated 120. The policy summary is presented to the user to verify that it is the correct policy 125 and corresponds to the policy information identified by the user. In accordance with one aspect of the technology, the policy summary includes information necessary to generate an EOI document. Once the accuracy of the policy information is verified, the policy summary and/or the information needed to generate the EOI document are stored on a server (or other storage device) 130 located separate and apart from the insurance company data storage. Step 135 illustrates how policy updates are entered by the user. In certain instances, mortgage lenders require that loan information and policy holder information match identically. For example, if John P. Sullivan applied for the loan and John P. Sullivan was listed as the owner of the insurance policy, the lender would require that the insurance policy and attendant EOI document list John P. Sullivan as the owner of the policy. In accordance with one aspect of the technology, the user is provided with an opportunity to update information that will be produced on the EOI document 140. Real time updates can be provided with respect to a newly added loss payee or minor modifications to a policy number (e.g., policy number formatting or other nominal changes). A manual update can be provided also with respect to minor modifications to the borrower information or the property owner information. In one aspect of the technology, the proposed changes to the information are screened by a module designed to limit the “value” of the information being changed. For example, in one aspect of the technology, a user would not be able to change the owner of the policy from John to James due to the difference in characters being changed. In a like example, the user would not be able to change an address from 155 North to 155 South, again, due to the difference in the characters being changed. However, the user would be able to modify the formatting from 115 N. to 115 North, for example. Once the change is made to the EOI document, changes will be made to the policy summary and sent back to the insurance company data. The insurance company data would then be updated based on information provided by the user. Once the insurance company data is updated, an updated EOI document is generated and forwarded to the lender. In one aspect of the technology, if more substantial changes were required, an additional step of sending the request to the insurance company for manual modification and a subsequent update to the EOI would be required.

When an EOI document is generated and/or updates have been made by a user and sent to an insurance company for acceptance, a notice (including the EOI document) is sent to a number of persons at step 150. In accordance with one aspect, electronic notice is provided to an insurance agent to let he/she know that a customer may be refinancing a home, selling a home, purchasing a vehicle, etc. This provides the insurance agent with notice that changes may be occurring with his or her customer and that contact from the insurance agent may be warranted. Notice is also sent to the loan originator who is attempting to close the loan as well as the lender and the borrower. While reference is made herein with respect to the sale or refinance of a home, aspects of the current technology can be used in connection with the generation of an EOI document in connection with any property where evidence of insurance is required. For example, where a landlord requires a renter to acquire rental insurance, either prior to occupancy or within a set period of time (e.g., 30 days after occupancy), the landlord and/or the renter can access the EOI system and generate an EOI document corresponding to an insurance policy obtained by the renter.

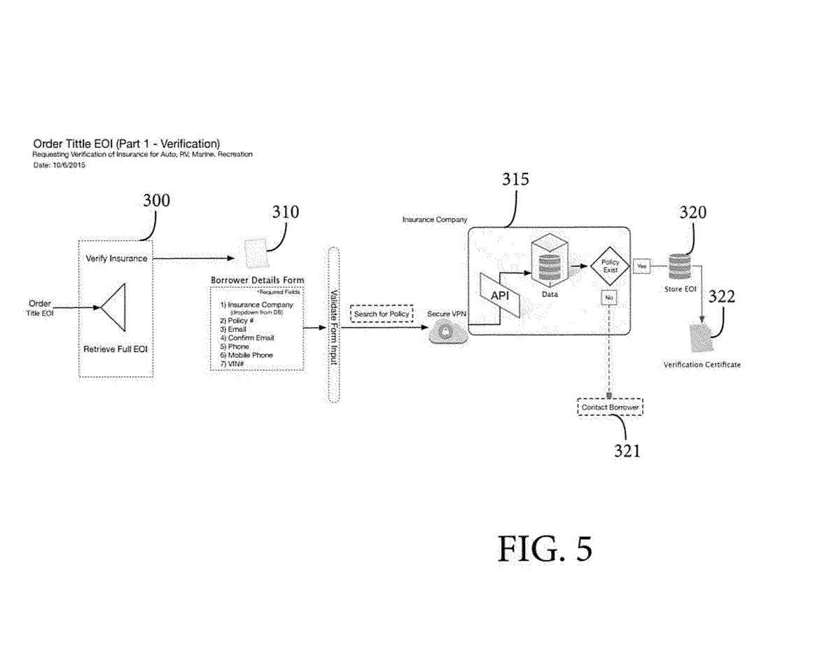

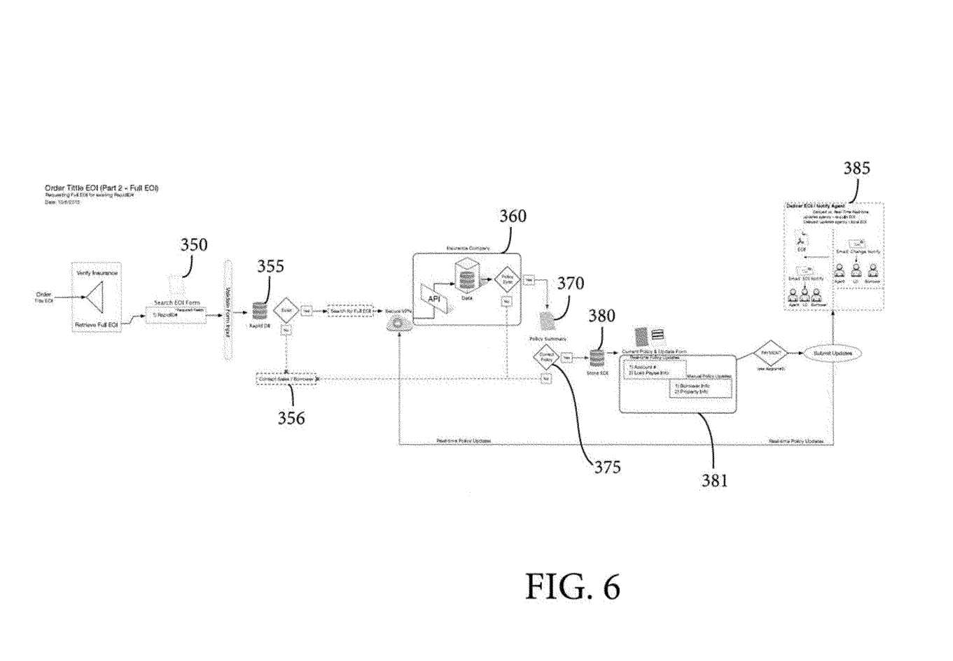

With reference now generally to FIGS. 5 and 6, in accordance with one aspect of the technology, a method and system is disclosed where a user is requesting an EOI document with respect to a vehicle (e.g., car, truck, boat, RV, motorcycle, etc.). The user accesses the EOI portal 300 and enters the borrower information at step 310, including, but not limited to the VIN number of the vehicle and the insurance policy number. A search of the insurance company data is conducted for the existence of a policy generally at step 315. If an insurance policy is located, an EOI code is assigned to the collateralized property and stored in a database at step 320. If an existing policy is not located, the borrower is contacted at step 321. Alternatively (or in addition to), a message is sent to the insurance company indicating that an EOI request has been made but it was not located in the insurance company's database. An EOI document is then generated verifying that the borrower has an auto insurance policy in place 322. While this EOI process may be conducted coincident to financing of a vehicle, it may not be possible for a borrower to update his or her policy to include the details of the financed vehicle until after he or she wishes to take possession of the vehicle. A lender may offer a borrower a grace period to make changes to his or her insurance policy to add the newly acquired vehicle. With reference now to FIG. 6, after a vehicle been assigned an EOI code, the borrower can request an updated EOI to verify that not only does a policy exist but that the automobile has been added to the policy subsequent to the financing of the vehicle. In this instance, the user need only enter the EOI code generated at step 320 into the EOI system at step 350 to begin the updated EOI process. The EOI system accesses the EOI database at step 355 to verify that a code exists and, if so, a full search of the insurance information database is conducted at step 360. If the code being entered into the system does not match an existing code, electronic notice is sent to the borrower and/or the lender at step 356. Once the insurance policy data has been located and the policy is confirmed to exist, a policy summary is generated 370. The policy summary is presented to the user to verify that it is the correct policy 375 and corresponds to the policy information identified by the user. In accordance with one aspect of the technology, the policy summary includes information necessary to generate an EOI document. Once the accuracy of the policy information is verified, the policy summary and/or the information needed to generate the EOI document are stored on a server (or other storage device) 380 located separate and apart from the insurance company data storage. When an EOI document is generated and/or updates have been made by a user and sent to an insurance company for acceptance, a notice (including the EOI document) is sent to a number of persons at step 385. In accordance with one aspect, electronic notice is provided to an insurance agent at step 385 to let he/she know that a customer may be refinancing a home, selling a home, purchasing a vehicle, etc. This provides the insurance agent with notice that changes may be occurring with his or her customer and that contact from the insurance agent may be warranted. Notice is also sent to the loan originator who is attempting to close the loan as well as the lender and the borrower. Step 381 of FIG. 6 discloses steps similar to those taken at steps 135 and 140 with respect to real-time updates to insurance information and manual corrections. Information related to policy ownership, identify of individuals, identity of collateralized property, etc. in insurance databases and lender databases is entered by different entities at different times. Accordingly, differences in the formatting of the same information is introduced during entry of this information into the different databases. The real time update and manual update modules permit minor differences in the information on the different databases to be reconciled quickly, and in some cases, automatically.

The methods and systems described herein may be used in connection with a network comprising a server, a storage component, and computer terminals as are known in the art. The server contains specialized processing components and specialized software and/or hardware components for implementing the EOI system. The server contains a processor for performing the related tasks of the EOI system and also contains internal memory for performing the necessary processing tasks. In addition, the server may be connected to an external storage component via the network. The processor is configured to execute one or more software applications to control the operation of the various modules of the server. The processor is also configured to access the internal memory of the server or the external storage to read and/or store data. The processor may be any conventional general purpose single or multi-chip processor as is known in the art. Different combinations of the numerous different aspects described in this application may be combined and/or separately utilized as suits a particular application.

The storage component contains memory for storing information used for performing the EOI system processes provided by the methods and apparatus described herein. Memory refers to electronic circuitry that allows information, typically computer data, to be stored and retrieved. Memory can refer to external devices or systems, for example, disk drives or other digital media. Memory can also refer to fast semiconductor storage, for example, Random Access Memory (RAM) or various forms of Read Only Memory (ROM) that are directly connected to the processor. Computer terminals represent any type of device that can access a computer network. Devices such as PDA's (personal digital assistants), cell phones, personal computers, lap top computers, tablet computers, mobile devices, or the like could be used. The computer terminals will typically have a display device and one or more input devices. The network may include any type of electronically connected group of computers including, for instance, Internet, Intranet, Local Area Networks (LAN), or Wide Area Networks (WAN). In addition, the connectivity to the network may be, for example, remote modem or Ethernet.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Non-limiting examples of certain “modules” are presented below. The structure of the module is not intended to be expressly limiting to the claims. Rather, it is intended to provide an example of how the technology may be employed on a special purpose computer (i.e., a computer programmed to perform particular functions pursuant to instructions from program software.).

### Example Module

* CHECK FOR EXISTING API_UUIDs
* Prevents duplicates in the ‘eoi_details’ DB. Returns eoi_id if true. Otherwise false.
* ----------------------------------- */
static function apiUUIDExists($api_uuid) {

global $db;
try {

$stmt = $db−>prepare(“SELECT eoi_id FROM eoi_details WHERE api_uuid =

:api_uuid”);

$stmt−>bindParam(‘:api_uuid’, $api_uuid);
$stmt−>execute( );
$exists_id = $stmt−>fetchColumn( );

} catch(PDOException $ex) {

die(‘ERROR: CL.’.get_called_class( )._LINE_);

}
if ($exists_id) return $exists_id;
else return false;

} // end apiUUIDExists( )
/* -----------------------------------
* MAKE TEMP EOI REAL
* Parses/copies the API-obtained temp blob data to a real EOI record (‘eoi details’)
* ----------------------------------- */
static function makeTempEOIReal($eoi_temp_id) {

global $db;
// Protect DB from changes if we hit a snag
$db−>beginTransaction( );

// Get the temporary EOI data blob
$temp_data = self::getTempEOI($eoi_temp_id);
if (!$temp_data) {

//!
die(“DEV ERROR: eoi_temp id “.$eoi_temp_id.” doesn’t exist”);

}
// Turn the saved/retrieved JSON into an array
$eoi = json_decode($temp data, true);
// PREVENT DUPLICATES
// Is there already an EOI with the same api_uuid in there?
$exists_id = self::apiUUIDExists($eoi[‘api_uuid’]);
if ($exists_id) {

// An EOI with the same uuid already exists. Return that record instead.
return self::get($exists_id);

| } | | |
|---|---|---|
| /* ----------------------------------- | | |
| * DETERMINE PRODUCT ID | | |
| * It’s in the .eoi temp file | | |
| 1 | Real Estate EOI | 12.00 |
| 2 | Title EOI | 12.00 |
| 3 | Custom Service | 24.00 |
| 4 | Real Estate EOI | 25.00 |

* ----------------------------------- */
$product_id = $eoi[‘rapideoi_product_id’];
/* -----------------------------------
* SAVE IT TO THE DB
// PARAMS
$params = array(

| ‘:eoi_status_id’ => 2, // 2 = preorder | |
|---|---|
| ‘:user_id’ => $_SESSION[‘jigowatt’][‘user_id’], | |
| ‘:product_id’ => $product_id, | |
| ‘:policy_number’ => $eoi[‘policy_number’], | |
| ‘:loan_number’ => $eoi[‘loan_number’], | |
| ‘:liability_limit’ => $eoi[‘liability_limit’], | |
| ‘:effective_date’ => date(‘Y-m-d’, strtotime($eoi[‘effective_date’])), | |
| ‘:expiration_date’ => date(‘Y-m-d’, strtotime($eoi[‘expiration_date’])), | |
| ‘:borrower_first_name’ => $eoi[‘borrower’][‘first’], | |
| ‘:borrower_last_name’ => $eoi[‘borrower’][‘last’], | |
| ‘:borrower_address1’ => $eoi[‘borrower’][‘address’], | |
| ‘:borrower_city’ => $eoi[‘borrower’][‘city’], | |
| ‘:borrower_state’ => $eoi[‘borrower’][‘state’], | |
| ‘:borrower_zip’ | => $eoi[‘borrower’][‘zip’], |

‘:borrower_email’ => $eoi[‘borrower’][‘zip’],
‘:borrower_phone1’=> preg_replace(‘ΛD+/’, ‘’, $eoi[‘borrower’][‘phone1’]),
‘:borrower_phone_mobile’ => preg_replace(‘ΛD+/’, ‘’,

$eoi[‘borrower’][‘phone_mobile’]),

| ‘:agent_first_name’ => $eoi[‘agent’][‘first’], | |
|---|---|
| ‘:agent_last_name’ => $eoi[‘agent’][‘last’], | |
| ‘:agent_address1’ => $eoi[‘agent’][‘address’], | |
| ‘:agent_city’ => $eoi[‘agent’][‘city’], | |
| ‘:agent_state’ => $eoi[‘agent’][‘state’], | |
| ‘:agent_zip’ => $eoi[‘agent’][‘zip’], | |
| ‘:agent_email’ => $eoi[‘agent’][‘email’], | |
| ‘:agent_phone1’=> preg_replace(‘ΛD+/’, ‘’, $eoi[‘agent’][‘phone’]), | |
| ‘:agent_phone_mobile’ => preg_replace(‘ΛD+/’, ‘’, $eoi[‘agent’][‘phone2’]), | |
| ‘:agency_customer_id’ => $eoi[‘agent’][‘agency_customer_id’], | |
| ‘:agent_company_name’ => $eoi[‘agent’][‘company_name’], | |
| ‘:property_address1’ => $eoi[‘property’][‘address’], | |
| ‘:property_city’ => $eoi[‘property’][‘city’], | |
| ‘:property_state’ => $eoi[‘property’][‘state’], | |
| ‘:property_zip’ => $eoi[‘property’][‘zip’], | |
| ‘:mortgage_company_name’ => $eoi[‘company’][‘company_name’], | |
| ‘:mortgage_address1’ => $eoi[‘company’][‘address’], | |
| ‘:mortgage_city’ => $eoi[‘company’][‘city’], | |
| ‘:mortgage_state’ => $eoi[‘company’][‘state’], | |
| ‘:mortgage_zip’ | => $eoi[‘company’][‘zip’], |

‘:loss_payee’ => $eoi[‘loss_payee’],
‘:api_uuid’ => $eoi[‘api_uuid’] // unique identifier for each API transaction.
Persists to real DB
);

// Prep that big array of params for INSERT-ing
$sq1 =“

INSERT INTO eoi_details (“.helpers::insertColumns($params).”)
VALUES (“.helpers::insertValues($params).”);

”;

try {

$stmt = $db−>prepare($sq1);
$stmt−>execute($params);
$eoi_id = $db−>lastInsertId( );

} catch(PDOException $ex) {

header(‘HTTP/1.1 500 QUERY ERRORS’);
die(‘insert fail: ‘.$ex−>getMessage( ));

}
if (!$eoi_id) die(“DEV ERROR: We didn’t get an EOI ID!”);

$db−>commit( );

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description describes the technology with reference to specific exemplary aspects. However, it will be appreciated that various modifications and changes can be made without departing from the scope of the present technology as set forth in the appended claims. The detailed description and accompanying drawings are to be regarded as merely illustrative, rather than as restrictive, and all such modifications or changes, if any, are intended to fall within the scope of the present technology as described and set forth herein.

More specifically, while illustrative exemplary aspects of the technology have been described herein, the present technology is not limited to these aspects, but includes any and all aspects having modifications, omissions, combinations (e.g., of aspects across various aspects), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus-function are expressly recited in the description herein. Accordingly, the scope of the technology should be determined solely by the appended claims and their legal equivalents, rather than by the descriptions and examples given above.

1. A method for procuring and tracking evidence of insurance, the method performed by one or more computer systems comprising a processor configured with executable instructions to:
(i) receive an evidence of insurance request from a user corresponding to a specific collateralized property, said request comprising information corresponding to the specific collateralized property;
(ii) generate and assign a unique code corresponding to the request for an evidence of insurance for the collateralized property;
(iii) create a profile of insurance information and storing said profile on a first database corresponding to the collateralized property;
(iv) access insurance information related to the collateralized property on a second database to obtain insurance information corresponding to the collateralized property;
(v) update the profile of insurance information on the first database;
(vi) confirm the existence of insurance for the collateralized property;
(vii) generate an electronic evidence of insurance document; and
(viii) transfer an evidence of insurance document to the user.

2. The method of claim 1, wherein the unique code is a permanent code and corresponds to the postal address of the collateralized property.

3. The method of claim 2, wherein the collateralized property comprises one of commercial real estate, multi-family housing, single-family housing, or vacation rental real estate.

4. The method of claim 1, wherein the unique code is a permanent code and corresponds to the VIN number of the collateralized property.

5. The method of claim 4, wherein the collateralized property comprises one of a car, a truck, a boat, a recreational vehicle, an ATV, a personal watercraft, or a motorcycle.

6. The method of claim 1, further comprising the step of providing updated information to be incorporated into the second database.

7. The method of claim 1, further comprising a database housing historical insurance information corresponding to the permanent unique code.

8. The method of claim 7, wherein the historical insurance information comprises the periods of time during which the collateralized property was insured, by what company the collateralized property was insured, and the amount of insurance policy during the period of time the collateralized property was insured.

9. The method of claim 1, wherein the processor is further configured to:
(i) receive a second evidence of insurance request from a user corresponding to the unique code for the collateralized property after having received the first evidence of insurance request;
(ii) create a second profile of insurance information and storing said second profile on the first database, said second profile corresponding to the unique code for the collateralized property;
(iii) access insurance information related to the collateralized property on a database to obtain insurance information corresponding to the collateralized property;
(iv) confirm the existence of insurance for the collateralized property;
(v) generate a current updated electronic evidence of insurance document; and
(vi) transfer a current evidence of insurance document to the user.

10. The method of claim 1, wherein the processor is further configured to compare insurance policy information related to the collateralized property with loan information related to the collateralized property and identify differences between the information.

11. The method of claim 10, wherein the processor is configured to compare the postal address of the collateralized property contained in the insurance policy with the postal address of the collateralized property contained in the loan documents and identify differences between the information.

12. The method of claim 11, further comprising the step of sending an automatic request to the insurance company to modify the postal address of the collateralized property contained in the insurance policy to conform with the postal address of the collateralized property contained in the loan documents.

13. The method of claim 1, further comprising sending notification to an insurance agent representing the property owner when a request for evidence of insurance has been made.

14. The method of claim 1, further comprising the step of requesting a batch of evidence of insurance documents in a single transaction, said batch of evidence of insurance documents corresponding to a plurality of collateralized property having previously been assigned a permanent unique code.

15. The method of claim 14, further comprising placing the permanent unique code on the evidence of insurance document in a machine readable format.

16. The method of claim 15, wherein the machine readable format comprises a bar code or a QR code.

17. A computer system specially programmed for procuring and tracking evidence of insurance, the computer system configured with executable instructions and comprising:
a dedicated processor which operates to:
(i) receive an evidence of insurance request from a user corresponding to a specific collateralized property, said request comprising a unique code previously assigned to the specific collateralized property, said code corresponding to insurance information for the collateralized property;
(ii) access a profile of insurance information on a first database corresponding to the unique code;
(iii) access insurance information related to the collateralized property on a second database to obtain insurance information corresponding to the collateralized property;
(iv) confirm the existence of insurance for the collateralized property;
(v) generate an electronic evidence of insurance document; and
(vi) transfer an evidence of insurance document to the user.

18. The system of claim 17, wherein the dedicated processor receives evidence of insurance requests from remote general purpose computers over a network connection.

19. The system of claim 18, wherein the dedicated processor is further configured with executable instructions to update the profile of insurance information on the first database when the information related to the collateralized property on the second database does not match information related to the collateralized property on loan documentation.

20. The system of claim 17, wherein the unique code is appended to a dynamic code corresponding to dynamic information related to the collateralized property.
